(19) United States
(12) Patent Application Publication
(10) Pub. No.: US 2006/0043627 A1
(43) Pub. Date: Mar. 2, 2006

(54) Wood cement board and method for the manufacturing thereof

(75) Inventors: Tadashi Sugita, Nagoya-shi (JP); Koichiro Endo, Nagoya-shi (JP); Atsushi Hattori, Nagoya-shi (JP); Satoshi Ikeda, Nagoya-shi (JP)

Correspondence Address: Donald S. Dowden;Cooper & Dunham LLP, 1185 Avenue of the Americas, New York, NY, 10036, US

(73) Assignee: Nichiha Corporation

(21) Appl. No.: 11/102,250

(22) Filed: Apr. 8, 2005

(30) Foreign Application Priority Data
Aug. 24, 2004 (JP) JP2004-243756

(51) Int. Cl. B29C 67/24

(52) U.S. Cl. 264/122

(57) ABSTRACT

The object of the present invention is to provide a light weight wood cement board having high strength and sufficient toughness. To attain the object, the present invention provides a wood cement board made of a cured raw material mixture of cementitious inorganic powder (C), a material containing silica (S), bundled wood fiber, and mica, wherein the weight ratio of said cementitious inorganic powder and said material containing silica is set to be in the range of between 40:60 and 50:50. The bundled wood fiber has a bulky shape, and gives good toughness to said wood cement board, with the mica improving its dimensional stability. In a case where the C/S is set to be in the range of 40:60 and 50:50, the curing of said board proceeds smoothly, leaving little unreacted material remaining in the board.

### FIELD OF THE INVENTION

The present invention relates to a wood cement board and a method for the manufacturing thereof.

### BACK GROUND OF THE INVENTION

Hitherto a wood cement board, which is a cement board using wood flake, wood wool, wood fiber(pulp), or the like as a reinforcement, has been provided (see such as Patent Literatures 1, 2, 3, 4)
Patent Literature 1: Tokkaihei 09-87002
Patent Literature 2: Tokkaihei 09-39154
Patent Literature 3: Tokkyo No.2913016
Patent Literature 4: Tokkai 2000-264701

For instance, said wood cement board may be manufactured by a method comprising the preparation of a mixture of raw materials containing cementitious inorganic powder and said wood reinforcement, adding a set amount of water, to said mixture, scattering said raw material mixture on a mold panel to form a mat of said raw material mixture, then curing said mat using the pressure (dry method). Since the water content in said raw material mixture may be low, (30 to 50% by weight), said dry method has been used advantageously, and is proven efficient.

### DISCLOSURE OF THE INVENTION

[Problems to be Solved by the Present Invention]

In traditional wood cement board using wood flake, since long fibers are not contained in said raw material mixture, the reinforcing effect caused by the intertwining of long fibers with each other may be unforeseen, so there is a problem in that the resulting lack of mat strength may cause the disintegration of said mat during handling, and that the reinforcing effect of the wood flake in the final product may be inadequate and that the mechanical strength of the resulting product will also be inadequate.

In the case of wood wool cement board, in which wood wool is used as a wood reinforcement, since said wood wool easily intertwines, there is a problem in that the uniform mixing of said raw material mixture may be difficult, and said raw material mixture will be hard to uniformly scatter on the base panel, makimg the dry method difficult to apply in the manufacture of wood wool cement board. Accordingly, to manufacture said wood wool cement board, a method having a low efficiency has been adopted, in which method, water is added to said raw material mixture, forming a paste, after which said paste is filled into a mold. Further, since wood wool is bulky, there are fears that the strength of an uncured mat produced by the intertwining of wood wool, as well as the strength of the final product, will be inadequate.

In the case of pulp cement board which uses pulp as a reinforcement, since the pulp in the raw material mixture may strongly intertwine, said raw material mixture may be hard to scatter uniformly on the mold panel, so that the dry method can not be applied to the manufacture of said pulp cement board, and alternatively the wet method, in which said raw material mixture is dispersed in water to prepare a slurry, after which a sheet is formed by papering said slurry, after which a plural number of said sheets are piled together to be pressed and cured, is applied.

Means to Solve Said Problems

As a means to solve said problems, the present invention provides a wood cement board made of a cured raw material mixture of a cementitious inorganic powder, a material containing silica, a bundled wood fiber, and mica, wherein the weight ratio of said cementitious inorganic powder and said material containing silica is set to be in the range of between 40:60 and 50:50. It is preferable that said bundled wood fiber has a branching and/or bending and/or folding bulky shape having a diameter of between 0.1 and 2.0 mm, a length of between 2 and 35 mm, and that the tensile strength of said bundled wood fiber alone is between 150 and 200 N/mm², and that said mica has an average particle size of between 150 and 200 μm, an aspect ratio of between 5 and 10, and that said mica is added to said raw material mixture in an amount of between 2 and 8% by weight.

Further, a preferable method for the manufacturing of said wood cement board comprises the preparation of a raw material mixture by the mixing of a cementitious inorganic powder, a material containing silica, bundled wood fiber, and mica with a set amount of water, then scattering said raw material mixture containing water on a base panel to form a mat of said raw material mixture, pressing said mat of said raw material mixture with heat to primarily cure it, and further curing said pressurized mat in an autoclave, wherein the weight ratio of said cementitious inorganic powder and said material containing silica is set to be in the range of between 40:60 and 50:50.

### EFFECT OF THE INVENTION

Since said bundled wood fiber used in the present invention does not intertwine strongly due to its shape in said raw material mixture, said raw material mixture can be scattered uniformly on the base panel. On the other hand, the fine fibers extending from the surface of said bundled wood fiber intertwine to improve the strength of the mat, and of the final product, while the bulky shape of said bundled wood fiber gives the product flexibility and toughness.

Considering the prevention of excessive water absorption by the product caused by the bulky shape of said bundled wood fiber, and resulting in the deterioration of both the product's freezing and disintegration resistance, the weight ratio of said cementitious inorganic powder and said material containing silica is set to be in the range of between 40:60 and 50:50, to improve the primary curing by pressing and heating, and the secondary curing in the autoclave, so that no unreacted cementitious inorganic powder or unreacted material containing silica remains.

Mica may improve dimensional stability and further improve the toughness and flexibility of the product, combined with said bundled wood fiber.

In the present invention, a wood cement board, which is light weight, high strength, sufficiently tough, and further, has a good dimensional stability, a good freezing and disintergration resistance, and a good nailing workability, is provided.

### PRECISE DESCRIPTION OT THE INVENTION AND PREFERED EMBODIMENT

The present invention is described precisely below.

[Cementitious Inorganic Powder]

The cementitious inorganic powder used in the present invention is a water curable inorganic powder containing calcium silicate as its main component, and said cementitious inorganic powder may be such as Portland cement, blast furnace cement in which blast furnace slag is mixed in with Portland cement, silica cement in which silica material such as volcanic ash, white earth, or the like is mixed in with Portland cement, fly ash cement in which fly ash is mixed in with Portland cement, alumina cement, blast furnace, or the like.

[Materials Containing Silica]

In the present invention, said material containing silica is used together with said cementitious inorganic powder to improve the curing reaction of said cementitious inorganic powder. Said material containing silica used in the present invention may be such as silica powder, silica sand, silica stone powder, water glass, silica fume, shirasu balloon, pearlite, diatomaceous earth, dolomite, or the like.

[Bundled Wood Fiber]

The preferable bundled wood fiber for use in the present invention has a branching and/or bending and/or folding bulky shape having a diameter of between 0.1 and 2.0 mm, and a length of between 2 and 35 mm, with the tensile strength of said bundled wood fiber alone being between 150 and 200 N/mm². Commonly the bulk specific gravity of said bundled wood fiber is between 0.03 and 0.05 g/cm³, and when said bundled wood fiber is screened with a screen having 4.75 openings, more than 40% by weight of said bundled wood fiber will remain on the screen. A lot of fine fibers extend from the surface of said bundled wood fiber, the sorts of wood appropriate for said bundled wood fiber, being such as yellow cypress, hinoki, or the like.

[Mica]

The preferable mica for use in the present invention has an average particle size of between 150 and 200 μm, and an aspect ratio of between 5 and 10, and is flake-shaped. Commonly mica has a lamellar structure, less water absorbability and is a highly elastic material, being tough enough to remarkably improve dimensional stability of the resulting wood cement board.

[Third Components]

Besides the aforementioned components, as the raw materials for said wood cement board of the present invention, inorganic fibers such as sepiolite, wollastnite, glass fiber, whisker, or the like, cement curing promoters such as calcium chloride, magnesium chloride, potassium sulfate, calcium sulfate, magnesium sulfate, aluminum sulfate, sodium aluminate, potassium aluminate, calcium formate, calcium acetate, calcium acrylate, water, glass, or the like, mineral powder such as vermiculite, pearlite, bentonite, or the like, a water proof agent or water repellent agent such as wax, paraffin, silicone, a surface active agent, or the like, a foamable thermoplastic bead, a foamed plastic, a wood reinforcement, such as wood flake, wood wool, wood fiber, pulp, bamboo fiber, hemp fiber, bagasse, chaff, rice straw, or the like may be added to said raw material mixture. Said illustrations do not limit the scope of the present invention.

[Preparation of Said Raw Material Mixture]

In the present invention, the weight ratio (C/S) of said cementitious inorganic powder (C) and said material containing silica(S) is set to be in the range of between 40:60 and 50:50, to promote the curing of said mat of said raw material mixture formed as described above, and not to leave behind any unreacted matter. Said bundled wood fiber is usually added in an amount in the range of between 15 and 35% by weight, but preferably between 20 and 30% by weight. In a case where said bundled wood fiber is added in an amount of less than 15% by weight, the reinforcing effect of said bundled wood fiber may be inadequate, and in a case where said bundled wood fiber is added in an amount of beyond 35% by weight, the dimensional stability, as well as the freezing and disintegration resistance of the resulting product may deteriorate.

Mica is usually added to said raw material mixture in an amount in the range of between 2 and 8% by weight. In a case where mica is added in an amount of less than 2% by weight, the dimensional stability of the resulting wood cement board will not sufficiently improve, and in a case where mica is added in an amount of beyond 8% by weight, said raw material mixture will be difficult to mix uniformly, and it may be difficult to manufacture a stable wood cement board, and the cost may increase.

[Manufacturing of Wood Cement Board]

To manufacture said wood cement board, the water content of the ingredient, which is a mixture of said components, is adjusted to be commonly 30 to 50% by weight by the addition of water to said ingredient, after which said ingredient is scattered on a base panel, such as a mold panel, transportation panel, flat panel, or the like, to form a mat, after which said mat is pressed and heated together with said base panel to be primarily cured.

Commonly, in said pressing and heating process, said mat is heated at a temperature of 60 to 100° C., and pressed at 6 to 7 N/mm².

After said primary curing, said primarily cured mat is removed from said base panel and cured at room temperature, or in an autoclave. The curing conditions in the autoclave may commonly have a humidity higher than 85% RH, at a temperature of 150˜180° C. for 10 to 18 hours. After curing in the autoclave, the resulting cured mat is then dried and surface-treated before becoming a finished product.

Said wood cement board of the present invention may have a two or three layer structure. In the case of a two layer structure, initially a raw material mixture containing a fine wood reinforcement, such as fine fiber, wood flour, or the like is scattered on said base panel to form a mat, after which a raw material mixture containing said bundled wood fiber is scattered on said mat, forming a mat having a two layer structure, after which said mat having two layer structure is pressed and heated, said mat of raw material mixture containing fine wood reinforcement forming a surface layer, having a thick structure, and said mat of raw material mixture containing bundled wood fiber forming a back layer, having a coarse structure.

Further, in a case where the board has a three layer structure, a further third raw material mixture containing fine wood reinforcement is scattered on said mat of raw material mixture containing said bundled wood fiber, forming a mat having a three layer structure, after which said mat is pressed, heated and cured in an autoclave, forming a core layer of said raw material mixture containing said bundled wood fiber, and a back layer of said third raw material mixture containing said fine wood reinforcement.

Further, to manufacture a board having a three layer structure, a pair of mats having two layers may be lapped together, and then pressed and heated.

In this case, a pair of mats are lapped together back to back, their layers of said raw material mixture containing said bundled wood fiber, contacting each other.

### EXAMPLES 1 TO 5, COMPARISONS 1 TO 5

The raw material mixture shown in Table 1 was scattered on a base panel to form a mat. The resulting mat was pressed at 65 kgs/cm², and then heated at 80° C. for 12 hours for the primary curing.

After said primary curing, the resulting primarily cured mat was removed from said base panel, and then cured in an autoclave at 165° C. for 12 hours.

The mechanical properties of each sample are shown in Table 1.

Insert Table 1

Referring to Table 1, it may be clear that each sample of EXAMPLES 1 to 5, which is the wood cement board of the present invention, has a bending strength of higher than 20 N/mm², and great enough Young's modulus and deflection degree to confirm that all samples in the EXAMPLES are of good toughness. Further, all samples in said EXAMPLES have good dimensional stability, good freezing and disintegration resistance, and good nailing work ability. The sample of COMPARISON 1, in which 40% by weight of said bundled wood fiber is added without adding mica, has a low bending strength, inferior dimensional stability, inferior freezing and disintegration resistance and poor toughness. The sample of COMPARISON 2, in which 15% by weight of said bundled wood fiber is added without adding mica, has a high specific gravity beyond 1.3 (1.33), poor bending strength, slightly poor toughness, and inferior nailing workability. On the other hand, the sample of COMPARISON 3, containing mica in an amount greater than 8% by weight (10% by weight), has poor bending strength, slightly poor toughness, and slightly inferior freezing and disintegration resistance. The sample of COMPARISON 4, whose C/S is larger than 50:50, has a slightly lesser degree of deflection, and an inferior nailing workability. Further, the sample of COMPARISON 5, whose C/S is smaller than 40:60, has a bending strength of less than 20 N/mm², a slightly lesser degree of deflection, and a slightly inferior freezing and disintegration resistance.

### POSSIBILITY OF INDUSTRIAL UTILITY

Said wood cement board of the present invention is light weight, high strength, and sufficiently tough, and further has a good dimensional stability, a good freezing and disintegration resistance, and a good nailing workability, so making said wood cement board advantageous for use as an exterior board for buildings and the like.

TABLE 1

| | | EXAMPLE 1 | EXAMPLE 2 | EXAMPLE 3 | EXAMPLE 4 | EXAMPLE 5 |
|---|---|---|---|---|---|---|
| Composition | Portland cement | 37.5 | 36 | 28 | 34 | 32.5 |
| (% by weight) | Silica sand | 37.5 | 36 | 42 | 34 | 32.5 |
| | Mica | 5 | 3 | 5 | 7 | 5 |
| | Bundled wood fiber | 20 | 25 | 25 | 25 | 30 |
| | Curing promotor *1 | 4 | 4 | 4 | 4 | 4 |
| | C/S Weight ratio | 50/50 | 50/50 | 40/60 | 50/50 | 50/50 |
| Physical | Specifric gravity in | 1.27 | 1.25 | 1.20 | 1.15 | 1.12 |
| properties | completely dry condition | | | | | |
| | Bending strength (N/mm) *2 | 22.5 | 23.4 | 23.0 | 22.3 | 22.0 |
| | Young's modulus | 7.3 | 6.9 | 6.5 | 6.3 | 6.0 |
| | (*10³N/mm) *2 | | | | | |
| | Deflection degree (mm) *2 | 2.8 | 3.0 | 3.1 | 3.2 | 3.4 |
| | Elougation ratio in water | 0.15 | 0.17 | 0.16 | 0.15 | 0.19 |
| | absorption(%) *3 | | | | | |
| | Contraction ratio inhumidity | 0.14 | 0.18 | 0.17 | 0.15 | 0.19 |
| | emission (%) *4 | | | | | |
| | Freezing and disintegration | ∘ | ∘ | ∘ | ∘ | ∘ |
| | resistance *5 | | | | | |
| | Nailing workability | ∘ | ∘ | ∘ | ∘ | ∘ |

| | | COMPAR- | COMPAR- | COMPAR- | COMPAR- | COMPAR- |
|---|---|---|---|---|---|---|
| | | ISON 1 | ISON 2 | ISON 3 | ISON 4 | ISON 5 |
| Composition | Portland cement | 30 | 42.5 | 30 | 45 | 25 |
| (% by weight) | Silica sand | 30 | 42.5 | 30 | 25 | 45 |
| | Mica | 0 | 0 | 10 | 5 | 5 |
| | Bundled wood fiber | 40 | 15 | 30 | 25 | 25 |
| | Curing promotor *1 | 4 | 4 | 4 | 4 | 4 |
| | C/S Weight ratio | 50/50 | 50/50 | 50/50 | 75/25 | 25/75 |
| Physical | Specifric gravity in | 0.83 | 1.33 | 1.04 | 1.25 | 1.52 |
| properties | completely dry condition | | | | | |
| | Bending strength (N/mm) *2 | 9.1 | 17.2 | 16.5 | 20.3 | 19.7 |
| | Young's modulus | 3.8 | 8.7 | 5.3 | 7.9 | 7.0 |
| | (*10³N/mm) *2 | | | | | |
| | Deflection degree (mm) *2 | 3.9 | 2.1 | 3.5 | 2.5 | 2.7 |
| | Elougation ratio in water | 0.27 | 0.15 | 0.16 | 0.17 | 0.18 |
| | absorption(%) *3 | | | | | |
| | Contraction ratio inhumidity | 0.30 | 0.16 | 0.16 | 0.18 | 0.17 |
| | emission (X) *4 | | | | | |
| | Freezing and disintegration | x | ∘ | Δ | ∘ | Δ |
| | resistance *5 | | | | | |
| | Nailing workability | ∘ | x | ∘ | x | ∘ |

*1 magnesium chloride (weight ratio enforcement)
*2 determined by the method in JISA 1408
*3 dimensional ratio change after water absorption for 24 hours
*4 dimensional ratio change after humidity emission for 24 hours at 80
*5 ASTM B method. After a 300 cycle test, the appearance of board samples, were observed, no change ∘, thickness swelling ration within 5% Δ, thickness swelling ratio greater than 5% x
*6 Using an air-nailer, nail is driven at a point 25 mm from the inside edge of the board sample. Good condition ∘, Cracking or breaking occurs x

1. A wood cement made of cured raw material mixture of a cementitious inorganic powder, a material containing silica, a bundled wood fiber, and mica, wherein the weight ratio of said cementitious inorganic powder and said material containing silica is between 40:60 and 50:50.

2. A wood cement board in accordance with claim 1, wherein said bundled wood fiber has a branching and/or bending and/or folding bulky shape having a diameter of between 0.1 and 2.0 mm, a length of between 2 and 35 mm, and a tensile strength of said bundled wood fiber alone is between 150 and 200 N/mm².

3. A wood cement board in accordance with claim 1, wherein said mica has an average particle size of between 150 and 200 μm, and an aspect ratio of between 5 and 10, said mica being added to said raw material mixture in an amount of between 2 and 8% by weight.

4. A method for the manufacturing of a wood cement board, comprising the preparation of a raw material mixture, by mixing a cementitious inorganic powder, a material containing silica, bundled wood fiber and mica with a set amount of water, then scattering said raw material mixture containing the water on a base panel to form a mat of said raw material mixture containing the water on a base panel to form a mat of said raw material mixture, then pressing said mat of said raw material mixture with heat to primarily cure it, and then to further cure said pressurized mat in an autoclave, wherein the weight ratio of said cementitious inorganic powder and said material containing silica is between 40:60 and 50:50.

5. A method for the manufacturing of a wood cement board in accordance with claim 4, wherein said bundled wood fiber has a branching and/or bending and/or folding bulky shape having a diameter of between 0.1 and 2.0 mm, a length of between 2 and 35 mm, and the tensile strength of said bundled wood fiber alone is between 150 and 200 N/mm².

6. A method for the manufacturing of a wood cement board in accordance with claim 4, wherein said mica has an average particle size of between 150 and 200 μm, and an aspect ratio of between 5 and 10, said mica being added to said raw material mixture in an amount of between 2 and 8% by weight.
